(19) United States
(12) Patent Application Publication
(10) Pub. No.: US 2024/0154275 A1
(43) Pub. Date: May 9, 2024

(54) POWER STORAGE CELL

(71) Applicant: TOYOTA JIDOSHA KABUSHIKI KAISHA, Toyota-shi, (JP)

(72) Inventors: Yoshiro OBAYASHI, Toyota-shi (JP); Kota OHATA, Toyota-shi (JP); Kazuhito KATO, Toyota-shi (JP); Takaaki GOTO, Seto-shi (JP); Shigeki TAKAIWA, Toyota-shi (JP)

(73) Assignee: TOYOTA JIDOSHA KABUSHIKI KAISHA, Toyota-shi, (JP)

(21) Appl. No.: 18/484,531

(22) Filed: Oct. 11, 2023

(30) Foreign Application Priority Data
Nov. 4, 2022 (JP) 2022-177391

(51) Int. Cl. H01M 50/578; H01M 50/103; H01M 50/15; H01M 50/55; H01M 50/553

(52) U.S. Cl. CPC H01M 50/578; H01M 50/103; H01M 50/15; H01M 50/55; H01M 50/553; H01M 2200/20

(57) ABSTRACT

A power storage cell includes a cell case and an electrode assembly. The cell case accommodates the electrode assembly. The cell case includes a case main body and a cover. The cover includes a first electrode terminal, an insulating member, an inversion plate, a cover main body, and a second electrode terminal. The cover main body electrically connects the inversion plate and the second electrode terminal to each other. The insulating member electrically insulates the first electrode terminal and the cover main body from each other. The inversion plate has a first surface. The first electrode terminal has a second surface. A groove group is formed in at least one of the first surface and the second surface.

This nonprovisional application is based on Japanese Patent Application No. 2022-177391 filed on Nov. 4, 2022 with the Japan Patent Office, the entire contents of which are hereby incorporated by reference.

### BACKGROUND

### Field

The present disclosure relates to a power storage cell.

### Description of the Background Art

Japanese Patent Application Laid-Open No. 2017-174732 discloses a short circuit device.

### SUMMARY

A power storage cell including a short circuit mechanism has been proposed. The short circuit mechanism includes an inversion plate. The inversion plate is curved to form a recessed surface, for example. For example, when gas is generated in the power storage cell, internal pressure may be increased. The increase in internal pressure may be a sign of some abnormality. When the internal pressure is increased, the inversion plate can be pressed by the pressure and the inversion plate (recessed surface) can be accordingly inverted. When the recessed surface is inverted, a protruding surface can be formed. When the inversion plate (protruding surface) is brought into contact with a portion of an electrode terminal (such as a terminal plate), a short circuit path can be formed. For example, a fuse may be melted and disconnected by a current flowing in the short circuit path. That is, the function of the power storage cell is disabled. However, for example, since a contact resistance between the portion of the electrode terminal and the protruding surface (inversion plate) is large, a desired amount of current may not flow.

Thus, an object of the present disclosure is to reduce a contact resistance between an electrode terminal and an inversion plate.

1. A power storage cell includes a cell case and an electrode assembly. The cell case accommodates the electrode assembly. The cell case includes a case main body and a cover. The case main body is provided with an opening. The cover closes the opening. The cover includes a first electrode terminal, an insulating member, an inversion plate, a cover main body, and a second electrode terminal. The cover main body supports the first electrode terminal and the second electrode terminal. The second electrode terminal has a polarity different from a polarity of the first electrode terminal. The cover main body electrically connects the inversion plate and the second electrode terminal to each other. The insulating member electrically insulates the first electrode terminal and the cover main body from each other.

The inversion plate has a first surface. The first electrode terminal has a second surface. The first surface faces the second surface. The first surface is curved in a direction away from the second surface. The power storage cell is configured such that an electrical contact point is formed between the first surface and the second surface by inversion of the inversion plate. A groove group is formed in at least one of the first surface and the second surface.

Hereinafter, a state in which the inversion plate is inverted is also referred to as an “inverted state”. Since the groove group (a plurality of grooves) is formed in at least one surface of the inversion plate and the first electrode terminal, electrical contact points (hereinafter, also simply referred to as “contact points”) between the inversion plate and the first electrode terminal are expected to be increased in the inversion state. With the increase in contact points, it is expected to reduce the contact resistance.

2. In the power storage cell according to “1”, a first groove group is formed in the first surface. The first groove group forms a first planar pattern. A second groove group is formed in the second surface. The second groove group forms a second planar pattern. The second planar pattern may be different from the first planar pattern, for example.

The groove group can form a predetermined planar pattern. When the groove groups are formed in both the inversion plate and the first electrode terminal, since the planar patterns are different from each other between the inversion plate and the first electrode terminal, it is expected to increase the contact points in the inversion state.

3. In the power storage cell according to “2”, when the first planar pattern and the second planar pattern are placed in the same plane, the groove group forming the first planar pattern may extend to intersect the groove group forming the second planar pattern, for example.

Since the groove extending direction of the first planar pattern and the groove extending direction of the second planar pattern intersect each other, it is expected to increase the contact points in the inverted state.

4. In the power storage cell according to “2” or “3”, the first planar pattern or the second planar pattern may include the groove group extending radially, for example. The first planar pattern or the second planar pattern may include the groove group extending annularly, for example.

For example, with the combination of the radial pattern and the annular pattern, it is expected to increase the contact points in the inverted state.

5. In the power storage cell according to “2”, when the first planar pattern and the second planar pattern are placed in the same plane, the groove group forming the first planar pattern may extend orthogonally to the groove group forming the second planar pattern, for example.

Since the groove extending direction of the first planar pattern and the groove extending direction of the second planar pattern are orthogonal to each other, it is expected to increase the contact point in the inverted state.

Hereinafter, an embodiment (hereinafter, simply referred to as “the present embodiment”) of the present disclosure will be described. It should be noted that the present embodiment does not limit the technical scope of the present disclosure. The present embodiment is illustrative in any respect. The present embodiment is non-restrictive. The technical scope of the present disclosure includes any modifications within the scope and meaning equivalent to the terms of the claims. For example, it is initially expected to extract freely configurations from the present embodiment and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic perspective view of a power storage cell according to the present embodiment.

FIG. 2 is an exploded perspective view of the power storage cell according to the present embodiment.

FIG. 3 is a schematic cross-sectional view of the power storage cell according to the present embodiment.

FIG. 4 is a schematic cross-sectional view around an inversion plate.

FIG. 5 is a schematic plan view showing a first example.

FIG. 6 is a schematic plan view showing a second example.

FIG. 7 is a schematic plan view showing a third example.

### DESCRIPTION OF THE PREFERRED EMBODIMENTS

### 1. Definitions of Terms and the Like

The descriptions of “comprising,” “including,” “having,” and variations thereof (e.g., “be composed of”) are open-ended. The open-end format may or may not further include additional elements in addition to essential elements. The description “consisting of” is in a closed format. However, even in the closed format, additional elements that are normally attendant impurities or that are irrelevant to the technology disclosed are not excluded. The description “consisting essentially of . . . ” is a semi-closed format. In semi-closed format, the addition of elements that do not substantially affect the basic and novel characteristics of the disclosed technology is allowed.

For example, “at least one of A and B” includes “A or B” and “A and B”. “At least one of A and B” may also be referred to as “A and/or B”.

In this embodiment, geometric terms (e.g., “parallel”, “vertical”, “orthogonal”, etc.) should not be construed in a strict sense. For example, “parallel” may be somewhat offset from “parallel” in a strict sense. Geometric terms may include, for example, tolerances, errors, etc. in design, operation, manufacturing, etc. The dimensional relationship in each figure may not match the actual dimensional relationship. Dimensional relationships (length, width, thickness, etc.) in each figure may have been changed to assist the reader in understanding. Further, some components may be omitted. In the drawings, the same or corresponding members may be denoted by the same reference numerals.

The “second electrode” has a polarity different from that of the “first electrode”. In this embodiment, the “negative electrode” is a “first electrode” and the “positive electrode” is a “second electrode”. That is, for example, the “negative electrode terminal” may be referred to as a “first electrode terminal”. For example, a “positive electrode terminal” may be referred to as a “second electrode terminal”. The other terms (e.g., “negative electrode tab” and the like) are the same. However, the polarity in the present embodiment is merely an example. The polarity may be reversed. That is, the negative electrode may be the second electrode, and the positive electrode may be the first electrode. Note that when simply referred to as an “electrode”, the “electrode” may be a generic term of a negative electrode and a positive electrode.

### 2. Power Storage Cell

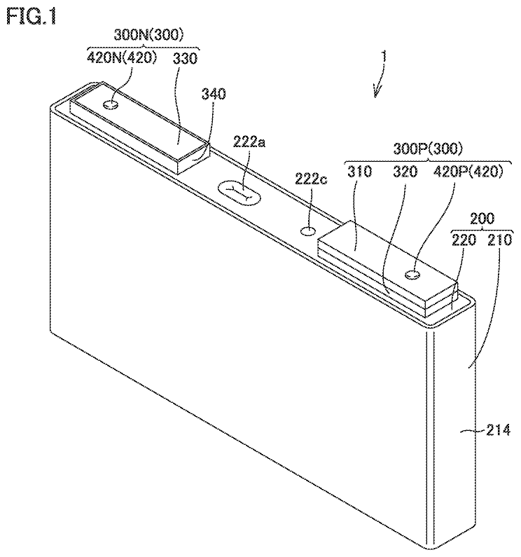

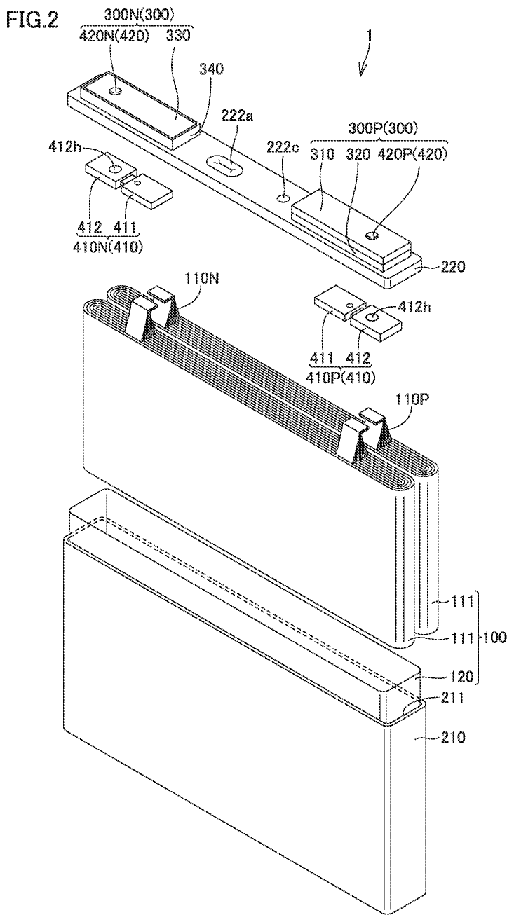

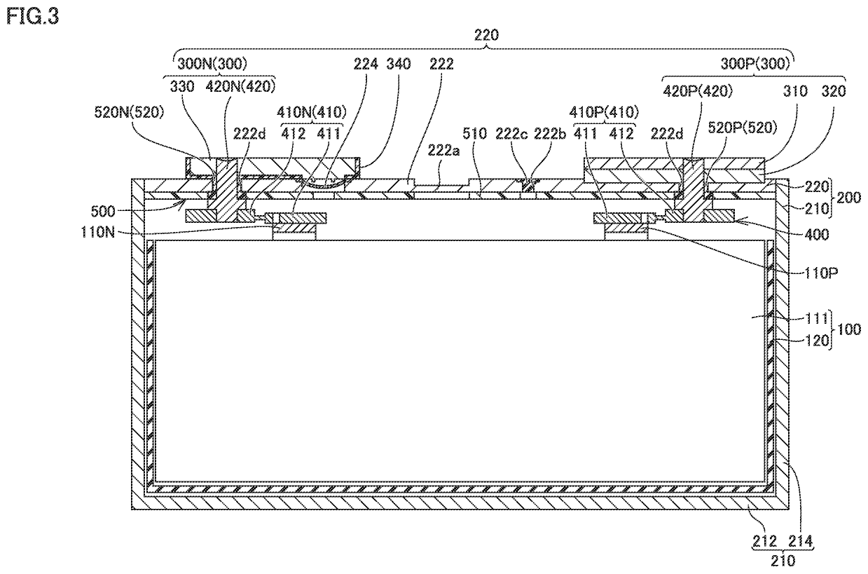

FIG. 1 is a schematic perspective view of a power storage cell according to the present embodiment. FIG. 2 is an exploded perspective view of the power storage cell according to the present embodiment. FIG. 3 is a schematic cross-sectional view of the power storage cell according to the present embodiment.

The power storage cell 1 may include, for example, an electrode assembly 100, a cell case 200, an electrode terminal 300, a coupling member 400, and an insulator 500 (see FIG. 3).

The electrode assembly 100 may include, for example, a plurality of unit electrode assemblies 111 and an insulating film 120 (see FIG. 2). The electrode assembly 100 may include, for example, two to four unit electrode assemblies 111. Each of the plurality of unit electrode assemblies 111 may include a plurality of positive electrode tabs 110P and a plurality of negative electrode tabs 110N. Each of the plurality of unit electrode assemblies 111 may have, for example, the same structure. Each of the plurality of unit electrode assemblies 111 may have a different structure, for example.

The unit electrode assembly 111 may have any structure. The unit electrode assembly 111 may be, for example, a laminated type. The unit electrode assembly 111 may be, for example, a wound type. The unit electrode assembly 111 may include, for example, a positive electrode sheet, a separator, and a negative electrode sheet. The positive electrode sheet, the negative electrode sheet, and the separator may have, for example, a belt-like planar shape.

The positive electrode sheet may include, for example, a metal foil and a positive electrode composite layer. The positive electrode composite layer may be disposed, for example, on the surface of the metal foil. For example, the positive electrode composite layer may be formed by coating the surface of the metal foil with the positive electrode slurry. A non-coated portion may be formed on the upper long side of the metal foil. No positive electrode composite layer was formed in the non-coated portion. In the non-coated portion, the metal foil is exposed. For example, a plurality of positive electrode tabs 110P may be bonded to the non-coated portion. The plurality of positive electrode tabs 110P may be spaced apart from each other.

The negative electrode sheet may include, for example, a metal foil and a negative electrode composite layer. The negative electrode composite layer may be disposed, for example, on the surface of the metal foil. For example, the negative electrode composite layer may be formed by coating the surface of the metal foil with the negative electrode slurry. A non-coated portion may be formed on the upper long side of the metal foil. No negative electrode composite layer was formed in the non-coated portion. In the non-coated portion, the metal foil is exposed. For example, a plurality of negative electrode tabs 110N may be bonded to the non-coated portion. The plurality of negative electrode tabs 110N may be spaced apart from each other.

For example, a laminate may be formed by laminating a positive electrode sheet, a separator, and a negative electrode sheet. The unit electrode assembly 111 can be formed by winding the laminate in a spiral shape. The unit electrode assembly 111 may be formed into a flat shape after winding. In the unit electrode assembly 111 (in a state after winding), each of the positive electrode tabs 110P may be arranged in the thickness direction. Each of the negative electrode tabs 110N may be arranged in the thickness direction. The “thickness direction” indicates a direction orthogonal to the plane of FIG. 3. Each of the positive electrode tab 110P and the negative electrode tab 110N may be spaced apart in the width direction. The “width direction” indicates a direction orthogonal to each of the thickness direction and the height direction.

For example, the insulating film 120 may collectively cover the peripheral surface and the bottom surface of the plurality of unit electrode assemblies 111 (see FIG. 2).

The cell case 200 houses the electrode assembly 100. The cell case 200 also houses an electrolyte solution (not shown). The cell case 200 is sealed. The cell case 200 includes a case main body 210 and a cover 220 (see FIG. 3).

The case main body 210 has an opening 211 that opens upward (see FIG. 2). The case main body 210 may be made of metal, for example. The case main body 210 may include aluminum (Al), for example. The case main body 210 includes a bottom wall 212 and a peripheral wall 214 (see FIG. 3). The bottom wall 212 may be rectangular and flat, for example. The peripheral wall 214 rises from the bottom wall 212. The peripheral wall 214 may be, for example, a quadrangular tube. The length of the peripheral wall 214 in the width direction may be longer than the length of the peripheral wall 214 in the thickness direction, for example. The length of the peripheral wall 214 in the height direction may be longer than the length of the peripheral wall 214 in the thickness direction, for example.

The cover 220 closes the opening 211. For example, the cover 220 may be bonded to the case main body 210 by laser welding. The cover 220 may have, for example, a flat plate shape. The cover 220 may be made of metal, for example. The cover 220 may include, for example, Al or the like. The cover 220 includes a negative electrode terminal 300N (first electrode terminal), an insulating member 340, an inversion plate 224, a cover main body 222, and a positive electrode terminal 300P (second electrode terminal) (see FIG. 3). The cover main body 222 may include, for example, a pressure release valve 222a, a liquid injection hole 222b, a sealing member 222c, and a pair of pin insertion holes 222d.

### 3. Short-Circuit Mechanism

The negative electrode terminal 300N includes a negative electrode terminal plate 330 and a negative electrode coupling pin 420N. The negative electrode terminal plate 330 may be made of metal, for example. The negative electrode terminal plate 330 may include, for example, copper (Cu), nickel (Ni), or the like. The insulating member 340 electrically insulates the negative electrode terminal 300N from the cover main body 222. The insulating member 340 may be made of, for example, a resin material.

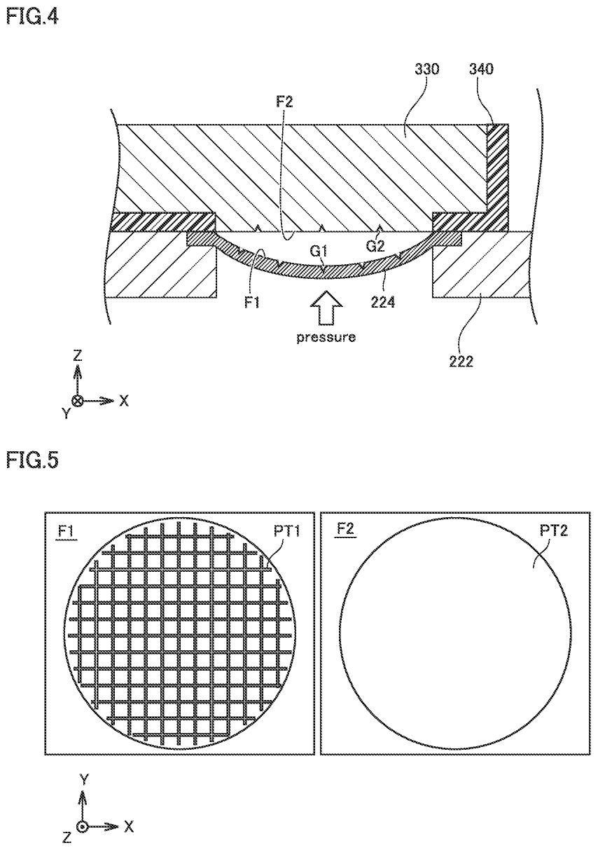

FIG. 4 is a schematic cross-sectional view around an inversion plate. The inversion plate 224 may have, for example, a dish-shaped or bowl-shaped outer shape. The inversion plate 224 may have a thickness of, for example, 0.1 to 1 mm. The inversion plate 224 may be made of, for example, an Al alloy. The inversion plate 224 is bonded to the cover main body 222. For example, the inversion plate 224 may be welded to the cover main body 222. The inversion plate 224 has a first surface F1. The negative electrode terminal plate 330 has a second surface F2. That is, the negative electrode terminal 300N (first electrode terminal) has the second surface F2. The first surface F1 faces the second surface F2. The inversion plate 224 has a downward convex cross-sectional shape in the height direction (Z-axis direction). The first surface F1 curves in a direction away from the second surface F2. The first surface F1 may form, for example, a concave surface. The second surface F2 may have any cross-sectional shape. The second surface F2 may be flat or curved. When the internal pressure of the cell case 200 becomes equal to or higher than the operating pressure, the inversion plate 224 is inverted in the height direction. The operating pressure can be arbitrarily set according to, for example, the size of the power storage cell 1. The operating pressure can be adjusted by, for example, the material and thickness of the inversion plate 224.

By the inversion of the inversion plate 224, a contact point is formed between the first surface F1 and the second surface F2. That is, the power storage cell 1 is configured such that a contact point is formed between the first surface F1 and the second surface F2 by the inversion of the inversion plate 224. A short circuit path is formed through the contact points. That is, the negative electrode terminal plate 330, the inversion plate 224, the cover main body 222, and the positive electrode terminal 300P are electrically connected to each other.

For example, by placing the fuse in the short circuit path, the fuse can be fused by the current flowing through the short circuit path. The fuses may be located anywhere in the short circuit path. For example, at least one of the positive electrode current collector plate 410P and the positive electrode coupling pin 420P may include a fuse. The fuse may have any structure. The fuse may include, for example, a notch, a thin portion, and the like. The fuse may comprise any fusible material. The fuse may include, for example, an alloy material, a resin material, or the like.

In FIG. 4, groove groups are formed on both the first surface F1 and the second surface F2. In the inverted state, it is expected that the groove groups increase the contact points. For example, even when a groove group exists in either the first surface F1 or the second surface F2, an increase in contact point can be expected.

The grooves may have any planar shape. The planar shape of the groove may be, for example, a linear shape, a point shape, or the like. The grooves may have any cross-sectional shape. The cross-sectional shape of the groove may be V-shaped, U-shaped, rectangular, or the like. The grooves may have any depth. For example, the depth of the grooves may be 0.1 to 0.9 times, or 0.3 to 0.7 times the thickness of the inversion plate 224. The groove group includes two or more grooves. The groove group may include, for example, 2 to 100, 5 to 50, or 5 to 20 grooves. A plurality of linear grooves may join each other. A plurality of point-shaped grooves may partially overlap. The linear grooves and the point grooves may be mixed.

In FIG. 4, a first groove group G1 is formed on the first surface F1. A second groove group G2 is formed in the second surface F2. The first groove group G1 forms a first planar pattern. The second groove group G2 forms a second planar pattern. The first planar pattern may be different from the second planar pattern. Since the first planar pattern is different from the second planar pattern, an increase in the contact point in the inverted state is expected. Each planar pattern may be formed of, for example, at least one of a line group and a point group. Each planar pattern may be regular or irregular.

### Example 1

FIG. 5 is a schematic plan view showing a first example. The “planar pattern” in the present embodiment includes a pattern in which no groove group is formed. For example, the first planar pattern PT1 may include a groove group extending in a lattice shape. The second planar pattern PT2 may be a flat surface having no groove. The grooves may extend linearly, for example. The grooves may extend, for example, in a curvilinear fashion. The peripheral edge of each planar pattern may be circular, oval, diamond, rectangular, or the like.

### Example 2

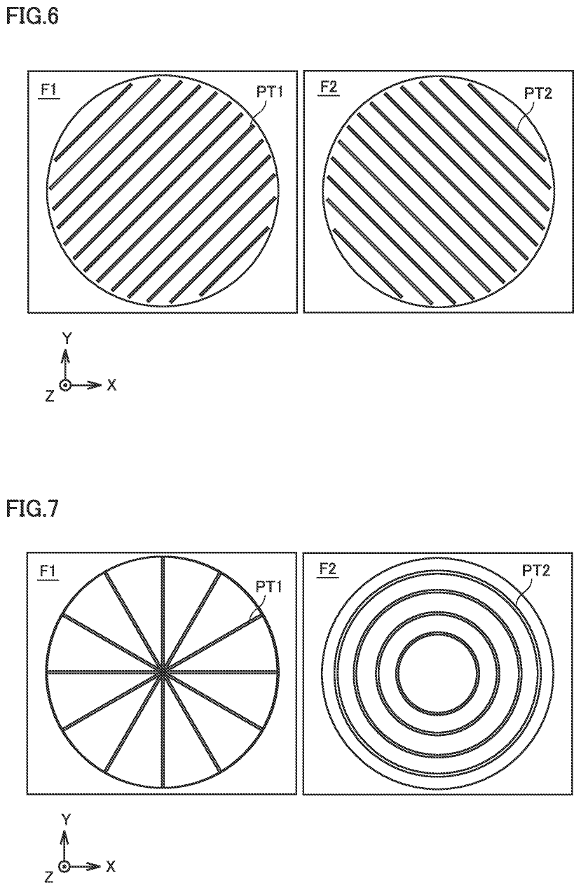

FIG. 6 is a schematic plan view showing a second example. For example, each of the first planar pattern PT1 and the second planar pattern PT2 may include a groove group extending linearly. The line indicates a set of parallel lines. For example, when the first planar pattern PT1 and the second planar pattern PT2 are placed in the same plane, the groove group forming the first planar pattern PT1 may extend so as to intersect the groove group forming the second planar pattern PT2. Since the extending directions of the grooves intersect between the first planar pattern PT1 and the second planar pattern PT2, an increase in the contact point in the inverted state is expected. The angle formed by the intersecting grooves may be, for example, 1 to 90 degrees, 10 to 80 degrees, or 30 to 70 degrees. For example, the groove group forming the first planar pattern PT1 may extend perpendicularly to the groove group forming the second planar pattern PT2. Since the extending directions of the grooves are orthogonal between the first planar pattern PT1 and the second planar pattern PT2, an increase in the contact point in the inverted state is expected.

### Example 3

FIG. 7 is a schematic plan view showing a third example. For example, the first planar pattern PT1 may include a groove group extending radially. For example, the second planar pattern PT2 may include a groove group extending in an annular shape. For example, the second planar pattern PT2 may include a groove group extending concentrically. The combination of the radial pattern and the annular pattern is expected to increase the contact point in the inverted state. Each of the first planar pattern PT1 and the second planar pattern PT2 may be point symmetrical or line symmetrical, for example.

Other Planar Patterns

For example, in the first to third examples, the first planar pattern PT1 and the second planar pattern PT2 may be replaced. For example, arbitrary planar patterns may be extracted from the first to third examples and combined arbitrarily. A single planar pattern may be formed by combining a plurality of planar patterns. One planar pattern may be formed by combining a part of an arbitrary planar pattern with all or a part of another planar pattern.

### 4. Other Members

The positive electrode terminal 300P includes a positive electrode terminal plate 310, a terminal block 320, and a positive electrode coupling pin 420P (see FIG. 3). The positive electrode terminal plate 310 may have, for example, a rectangular parallelepiped outer shape. The positive electrode terminal plate 310 may be made of metal, for example. The positive electrode terminal plate 310 may contain, for example, Al or the like.

The terminal block 320 may have, for example, a rectangular parallelepiped outer shape. The terminal block 320 may be made of metal, for example. The terminal block 320 may have, for example, a material different from that of the positive electrode terminal plate 310. The terminal block 320 may include, for example, iron (Fe). The terminal block 320 is bonded to the upper surface of the cover main body 222. A positive electrode terminal plate 310 is bonded to the upper surface of the terminal block 320. The case main body 210 and the cover 220 are electrically connected to the positive electrode terminal plate 310 via the terminal block 320. The case main body 210, the cover 220, and the positive electrode terminal plate 310 have the same polarity. Through holes are formed in each of the positive electrode terminal plate 310 and the terminal block 320. The positive electrode coupling pin 420P is inserted through the through hole.

The coupling member 400 connects the plurality of positive electrode tabs 110P and the electrode terminal 300. The coupling member 400 connects the plurality of negative electrode tabs 110N and the electrode terminal 300. The coupling member 400 includes a current collector plate 410. The current collector plate 410 is connected to a plurality of tabs. The current collector plate 410 includes a positive electrode current collector plate 410P and a negative electrode current collector plate 410N.

The positive electrode current collector plate 410P is bonded to a plurality of positive electrode tabs 110P. The positive electrode current collector plate 410P includes a first flat plate portion 411 and a second flat plate portion 412.

A plurality of positive electrode tabs 110P are bonded to the first flat plate portion 411. A through hole is formed in the first flat plate portion 411. The plurality of positive electrode tabs 110P are bonded to the lower surface of the first flat plate portion 411. However, the plurality of positive electrode tabs 110P may be bonded to the upper surface of the first flat plate portion 411.

The second flat plate portion 412 is disposed outside the first flat plate portion 411 in the width direction. A coupling hole 412h is formed in the second flat plate portion 412 (see FIG. 2). A thin portion may be formed between the second flat plate portion 412 and the first flat plate portion 411 (see FIG. 3).

The negative electrode current collector plate 410N is bonded to a plurality of negative electrode tabs 110N. The negative electrode current collector plate 410N may have, for example, the same structure as the positive electrode current collector plate 410P.

The coupling pin 420 connects the current collector plate 410 and the electrode terminal 300. The coupling pin 420 includes a positive electrode coupling pin 420P and a negative electrode coupling pin 420N.

The positive electrode coupling pin 420P connects the positive electrode current collector plate 410P and the positive electrode terminal plate 310. The positive electrode coupling pin 420P may have, for example, a cylindrical outer shape. When the positive electrode coupling pin 420P is inserted into the coupling hole 412h, the lower end of the positive electrode coupling pin 420P is connected to the second flat plate portion 412. The upper end of the positive electrode coupling pin 420P may be fixed to the positive electrode terminal plate 310 by caulking, for example.

The negative electrode coupling pin 420N connects the negative electrode current collector plate 410N and the negative electrode terminal plate 330. The negative electrode coupling pin 420N may have, for example, a cylindrical outer shape. When the negative electrode coupling pin 420N is inserted into the coupling hole 412h, the lower end of the negative electrode coupling pin 420N is connected to the second flat plate portion 412. The upper end of the negative electrode coupling pin 420N may be fixed to the negative electrode terminal plate 330 by caulking, for example.

The insulator 500 insulates the coupling member 400 from the cell case 200. Insulator 500 includes an insulating sheet 510 and an insulating gasket 520.

The insulating sheet 510 is connected to the lower surface of the cover main body 222. A through hole is formed in a portion of the insulating sheet 510 which overlaps the pressure release valve 222a in the height direction, a portion which overlaps the liquid injection hole 222b, a portion which overlaps the pin insertion hole 222d, and a portion which overlaps the inversion plate 224.

The insulating gasket 520 has a shape surrounding the coupling pin 420. The insulating gasket 520 insulates the coupling pin 420 from the cell case 200. The insulating gasket 520 includes a positive electrode gasket 520P and a negative electrode gasket 520N.

The positive electrode gasket 520P covers the positive electrode coupling pin 420P. The positive electrode gasket 520P has a cylindrical outer shape. The negative electrode gasket 520N covers the negative electrode coupling pin 420N. The negative electrode gasket 520N may have the same structure as the positive electrode gasket 520P.

What is claimed is:

1. A power storage cell comprising:
a cell case; and
an electrode assembly, wherein
the cell case accommodates the electrode assembly,
the cell case includes a case main body and a cover,
the case main body is provided with an opening,
the cover closes the opening,
the cover includes a first electrode terminal, an insulating member, an inversion plate, a cover main body, and a second electrode terminal,
the cover main body supports the first electrode terminal and the second electrode terminal,
the second electrode terminal has a polarity different from a polarity of the first electrode terminal,
the cover main body electrically connects the inversion plate and the second electrode terminal to each other,
the insulating member electrically insulates the first electrode terminal and the cover main body from each other,
the inversion plate has a first surface,
the first electrode terminal has a second surface,
the first surface faces the second surface,
the first surface is curved in a direction away from the second surface,
the power storage cell is configured such that an electrical contact point is formed between the first surface and the second surface by inversion of the inversion plate, and
a groove group is formed in at least one of the first surface and the second surface.

2. The power storage cell according to claim 1, wherein
a first groove group is formed in the first surface,
the first groove group forms a first planar pattern,
a second groove group is formed in the second surface,
the second groove group forms a second planar pattern, and
the second planar pattern is different from the first planar pattern.

3. The power storage cell according to claim 2, wherein
when the first planar pattern and the second planar pattern are placed in the same plane, the groove group forming the first planar pattern extends to intersect the groove group forming the second planar pattern.

4. The power storage cell according to claim 2, wherein
the first planar pattern or the second planar pattern includes the groove group extending radially, and
the first planar pattern or the second planar pattern includes the groove group extending annularly.

5. The power storage cell according to claim 2, wherein
when the first planar pattern and the second planar pattern are placed in the same plane, the groove group forming the first planar pattern extends orthogonally to the groove group forming the second planar pattern.
